(19) United States
(12) Patent Application Publication
(10) Pub. No.: US 2021/0188505 A1
(43) Pub. Date: Jun. 24, 2021

(54) CABLE TIE WRAPPING DEVICE

(71) Applicant: Ricardo Bazile, Naples, FL (US)

(72) Inventor: Ricardo Bazile, Naples, FL (US)

(21) Appl. No.: 16/723,924

(22) Filed: Dec. 20, 2019

(51) Int. Cl. B65D 63/10; B65B 13/02

(52) U.S. Cl. CPC B65D 63/1027; B65B 13/027

(57) ABSTRACT

A cable tie wrapping device, including a pole, a tie wrapping assembly disposed on a first end of the pole to wrap a cable tie around a cable, and to cut the cable tie in response to the cable tie being tied, and a handle assembly disposed on a second end of the pole to control the tie wrapping assembly in response to manipulation of the handle assembly.

### BACKGROUND

### 1. Field

The present general inventive concept relates generally to a wrapping device, and particularly, to a cable tie wrapping device.

### 2. Description of the Related Art

High voltage cable management is important to ensure safety in a public environment. High voltage cables can pose a danger to the public if left unmanaged and unorganized because a loose cable can cause serious injury to a passerby that touches it.

Traditional methods of tying high voltage cables requires a worker to carry a large ladder for set up, safety tools, sturdy boots, and possibly enlist an assistant to hold the ladder steady, which costs time and energy. Additionally, the possibility of falling off the ladder adds an unnecessary degree of difficulty to an already challenging task.

Specifically, a portion of a body of the worker is exposed to electrocution by being in close proximity to the high voltage cables.

Therefore, there is a need for cable tie wrapping device that protects the worker from exposure to the high voltage cables by allowing the high voltage cables to be tied at a distance.

### SUMMARY

The present general inventive concept provides a cable tie wrapping device.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a cable tie wrapping device, including a pole, a tie wrapping assembly disposed on a first end of the pole to wrap a cable tie around a cable, and to cut the cable tie in response to the cable tie being tied, and a handle assembly disposed on a second end of the pole to control the tie wrapping assembly in response to manipulation of the handle assembly.

The tie wrapping assembly may include a tie connecting member to receive the cable tie on an interior surface thereof, a retractable blade disposed on at least a portion of the tie connecting member to extend in response to the tie connecting member being closed around the cable, a tie wrapping motor connected to the tie connecting member to close the tie connecting member in a first rotation, and to open the tie connecting member in a second rotation opposite with respect to the first rotation, and an illumination unit disposed on at least a portion of the tie wrapping assembly to illuminate a surrounding area.

The handle assembly may include a handle to facilitate gripping thereof, and a lever pivotally disposed on at least a portion of the handle to activate the tie wrapping assembly in response to moving the lever.

The handle assembly may further include a battery level indicator to indicate a level of charge of a battery, an input connector disposed on at least a portion of the handle to receive an external power source, such that the input connector receives external power to charge the battery, and an output connector disposed on at least a portion of the handle to connect to an external device, such that the output connector charges the external device.

The cable tie wrapping device may further include a tie wrap compartment disposed on at least a portion of the pole to store at least one other cable tie therein.

The cable tie wrapping device may further include an electromagnetic shielding unit disposed on at least a portion of the tie wrapping assembly to impede a current from the cable from being transferred to at least one of the pole, the tie wrapping assembly, and the handle assembly.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a side view of a cable tie wrapping device, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the FIGURES, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Cable Tie Wrapping Device 100
Pole 110
Tie Wrapping Assembly 120
Tie Connecting Member 121
First Section 121a
Second Section 121b
Hinge 121c
Gap 121d
Retractable Blade 122
Tie Wrapping Motor 123
Illumination Unit 124
Tie Loader 125
Handle Assembly 130
Handle 131
Lever 132
Battery 133
Battery Level Indicator 134
Input Connector 135
Output Connector 136
Light Button 137
Tie Wrap Compartment 140
Electromagnetic Shielding Unit 150

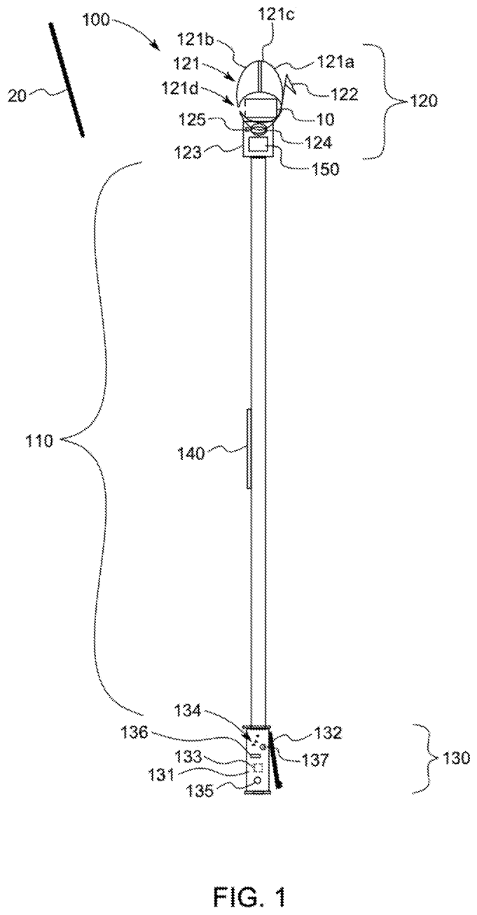

FIG. 1 illustrates a side view of a cable tie wrapping device 100, according to an exemplary embodiment of the present general inventive concept.

The cable tie wrapping device 100 may be constructed from at least one of metal, plastic, wood, glass, and rubber, etc., but is not limited thereto.

The cable tie wrapping device 100 may include a pole 110, a tie wrapping assembly 120, a handle assembly 130, a tie wrap compartment 140, and an electromagnetic shielding unit 150, but is not limited thereto.

Referring to FIG. 1, the pole 110 may have a cylindrical shape. However, the pole 110 may be a rectangular prism, pentagonal, hexagonal, octagonal, or any other shape known to one of ordinary skill in the art, but is not limited thereto.

The pole 110 may have a predetermined length and width based on a preference of a user. For example, the pole 110 may have a length of eight feet and a diameter of three-fourths of a foot. Also, the pole 110 may be constructed of aluminum and/or steel, but any strong and durable material may be used. Alternatively, a non-electricity conducting material (e.g., wood, plastic, glass) may be used.

The tie wrapping assembly 120 may include a tie connecting member 121, a retractable blade 122, a tie wrapping motor 123, an illumination unit 124, and a tie loader 125, but is not limited thereto.

The tie wrapping assembly 120 may be disposed on a first end of the pole 110.

The tie connecting member 121 may include a first section 121a, a second section 121b, a hinge 121c, and a gap 121d, but is not limited thereto.

The tie connecting member 121 may have a cable tie 10 connected therein. More specifically, the tie connecting member 121 may receive the cable tie 10 on an interior surface of the first section 121a and the second section 121b, in an open loop formation.

Referring again to FIG. 1, the first section 121a may be hingedly disposed on at least a portion of a first end of the second section 121b at the hinge 121c, such that the first section 121a may pivot from open in a first position to at least partially closed in a second position. As such, the first section 121a may pivot towards a center point between the first section 121a and the second section 121b, such that the first section 121a moves a first end of the cable tie 10 towards a second end of the cable tie 10, such that the first end and the second end are connected via a cable connector disposed on the cable tie 10. It is well known in the art that cable ties have a cable connector disposed on an end of the cable ties, such that the cable ties may be closed in a closed loop.

Alternatively, the first section 121a may pivot away from the center point between the first section 121a and the second section 121b, such that the first section 121a resets to its original position to receive another cable tie 10.

The gap 121d may receive at least a portion of at least one high voltage cable 20 therethrough. Although, a high voltage cable 20 is discussed, the cable tie wrapping device 100 may be used on any type of cable 20. As such, the cable tie 10 may receive at least a portion of the at least one high voltage cable 20 due to being in the open loop formation, as discussed above. Subsequently, the first section 121a may close to tie the cable tie 10 around the at least one high voltage cable 20.

Furthermore, the retractable blade 122 may be disposed on at least a portion of the tie wrapping assembly 120, such as on the tie connecting member 121. The retractable blade 122 may be spring activated to extend to cut the cable tie 10 in response to the first section 121a being closed around the at least one high voltage cable 20, such that the cable tie 10 may be tied. Also, the retractable blade 122 may retract within the tie wrapping assembly 120.

The tie wrapping motor 123 may be mechanically and/or electrically connected to the tie connecting member 121. The tie wrapping motor 123 may be any kind of motor. For example, the tie wrapping motor 123 may be a twelve-volt direct current (DC) motor. The first section 121a may pivot in response to a rotation of the tie wrapping motor 123. In other words, the tie wrapping motor 123 may open the first section 121a with respect to the second section 121b in a first rotation, and close the first section 121a with respect to the second section 121b in a second rotation opposite with respect to the first rotation.

Also, the retractable blade 122 may be extracted to cut the cable tie 10 in response to another rotation of the tie wrapping motor 123, different with respect to the first rotation and the second rotation, after the first section 121a is closed, such that the cable tie 10 is tied around the at least one high voltage cable 20.

The illumination unit 124 may include an incandescent light and a light-emitting diode (LED), but is not limited thereto.

The illumination unit 124 may be disposed on at least a portion of the tie wrapping assembly 120. The illumination unit 124 may illuminate a surrounding area to facilitate visibility by the user. More specifically, the illumination unit 124 may illuminate a dark area, such that the user may see where the at least one high voltage cable 20 is located. Also, the illumination unit 124 may have three different levels of brightness, such as a low luminosity level, an intermediate luminosity level, and a high luminosity level. In other words, the low luminosity level may have the lowest luminosity, the high luminosity level may have the brightest luminosity, and the intermediate luminosity level may have a luminosity level between the low luminosity level and the high luminosity level.

The tie loader 125 may be disposed on at least a portion of the tie wrapping assembly 120. The tie loader 125 may include a compartment to store at least one cable tie 10 therein. For example, the tie loader 125 may store twenty cable ties, but is not limited thereto.

Moreover, the tie loader 125 may springingly load the another cable tie 10 within the tie connecting member 121 after the first section 121a has opened to its original position, such that a new cable tie 10 may be installed at another portion of the at least one high voltage cable 20 and/or at least one other high voltage cable 20.

The handle assembly 130 may include a handle 131, a lever 132, a battery 133, a battery level indicator 134, an input connector 135, an output connector 136, and a light button 137, but is not limited thereto.

The handle assembly 130 may be disposed on a second end of the pole 110.

The handle 131 may include a rubber surface and/or a textured surface (e.g., a knurled surface) to facilitate gripping thereof.

The lever 132 may be disposed on at least a portion of the handle 131. The handle assembly 130 may control the tie wrapping assembly 120 in response to a manipulation of the handle assembly 130. More specifically, the lever 132 may be moved (i.e. pivot) by being squeezed by the user to activate the tie wrapping motor 123. In other words, the tie wrapping motor 123 may rotate in response to squeezing the lever 132 by the user, such that the first section 121a may close with respect to the second section 121b, such that the cable tie 10 may be tied, and subsequently, cut by the blade 122.

The battery 133 may include lithium-ion, nickel cadmium, nickel metal hydride, alkaline, etc., but is not limited thereto. For example, the battery 133 may be a twelve-volt lithium battery.

The battery 133 may provide power to the tie wrapping assembly 120, but is not limited thereto.

The battery level indicator 134 may have different levels to indicate a current battery level, such as fully charged, half charge, low charge, and/or no energy.

The input connector 135 may be disposed on at least a portion of the handle assembly 130. The input connector 135 may receive an external power source to recharge the battery 133 and/or provide direct power to the tie wrapping assembly 120.

The output connector 136 may be disposed on at least a portion of the handle assembly 130. The output connector 136 may connect to an external device, such as a mobile device (e.g., a cell phone, a tablet) to charge the external device.

The light button 137 may be disposed on at least a portion of the handle assembly 130. The light button 137 may be depressed a first time and/or for a first predetermined duration of time to illuminate the illumination unit 124 at the low luminosity level. The light button 137 may be depressed a second time and/or for a second predetermined duration of time to illuminate the illumination unit 124 at the intermediate luminosity level. The light button 137 may be depressed a third time and/or for a third predetermined duration of time to illuminate the illumination unit 124 at the high luminosity level. The light button 137 may be depressed a fourth time and/or for a fourth predetermined duration of time to turn off the illumination unit 124.

The tie wrap compartment 140 may be disposed on at least a portion of the pole 110. The tie wrap compartment 140 may store a plurality of cable ties 10 therein. For example, the tie wrap compartment 140 may store one hundred cable ties, such that the user may transfer some of the cable ties to the tie loader 125 for more immediate use.

The electromagnetic shielding unit 150 may include a sheet metal, a metal screen, and/or a metal foam.

The electromagnetic shielding unit 150 may be disposed on at least a portion of the tie wrapping assembly 120. The electromagnetic shielding unit 150 may prevent electric shock to the user by impeding a current from the at least one high voltage cable 20 from being transferred to at least one of the pole 110, the tie wrapping assembly 120, and the handle assembly 130. As such, the electromagnetic shielding unit 150 may prevent the user from injury.

Therefore, the cable tie wrapping device 100 may prevent injury to the user by increasing a range from which the cable tie 10 is wrapped on the at least one high voltage cable 20. As such, the cable tie wrapping device 100 may reach the at least one high voltage cable 20 without the user climbing a ladder.

The present general inventive concept may include a cable tie wrapping device 100, including a pole 110, a tie wrapping assembly 120 disposed on a first end of the pole 110 to wrap a cable tie 10 around a cable 20, and to cut the cable tie 10 in response to the cable tie 10 being tied, and a handle assembly 130 disposed on a second end of the pole 110 to control the tie wrapping assembly 120 in response to manipulation of the handle assembly 130.

The tie wrapping assembly 120 may include a tie connecting member 121 to receive the cable tie 10 on an interior surface thereof, a retractable blade 122 disposed on at least a portion of the tie connecting member 121 to extend in response to the tie connecting member 121 being closed around the cable 20, a tie wrapping motor 123 connected to the tie connecting member 121 to close the tie connecting member 121 in a first rotation, and to open the tie connecting member 121 in a second rotation opposite with respect to the first rotation, and an illumination unit 124 disposed on at least a portion of the tie wrapping assembly 120 to illuminate a surrounding area.

The handle assembly 130 may include a handle 131 to facilitate gripping thereof, and a lever 132 pivotally disposed on at least a portion of the handle 131 to activate the tie wrapping assembly 120 in response to moving the lever 132.

The handle assembly 130 may further include a battery level indicator 134 to indicate a level of charge of a battery 133, an input connector 135 disposed on at least a portion of the handle 131 to receive an external power source, such that the input connector 135 receives external power to charge the battery 133, and an output connector 136 disposed on at least a portion of the handle 131 to connect to an external device, such that the output connector 136 charges the external device.

The cable tie wrapping device 100 may further include a tie wrap compartment 140 disposed on at least a portion of the pole 110 to store at least one other cable tie 10 therein.

The cable tie wrapping device 100 may further include an electromagnetic shielding unit 150 disposed on at least a portion of the tie wrapping assembly 120 to impede a current from the cable 20 from being transferred to at least one of the pole 110, the tie wrapping assembly 120, and the handle assembly 130.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A cable tie wrapping device, comprising:
a pole;
a tie wrapping assembly disposed on a first end of the pole to wrap a cable tie around a cable, and to cut the cable tie in response to the cable tie being tied; and
a handle assembly disposed on a second end of the pole to control the tie wrapping assembly in response to manipulation of the handle assembly.

2. The cable tie wrapping device of claim 1, wherein the tie wrapping assembly comprises:
a tie connecting member to receive the cable tie on an interior surface thereof;
a retractable blade disposed on at least a portion of the tie connecting member to extend in response to the tie connecting member being closed around the cable;
a tie wrapping motor connected to the tie connecting member to close the tie connecting member in a first rotation, and to open the tie connecting member in a second rotation opposite with respect to the first rotation; and
an illumination unit disposed on at least a portion of the tie wrapping assembly to illuminate a surrounding area.

3. The cable tie wrapping device of claim 1, wherein the handle assembly comprises:
a handle to facilitate gripping thereof; and
a lever pivotally disposed on at least a portion of the handle to activate the tie wrapping assembly in response to moving the lever.

4. The cable tie wrapping device of claim 3, wherein the handle assembly further comprises:
a battery level indicator to indicate a level of charge of a battery;
an input connector disposed on at least a portion of the handle to receive an external power source, such that the input connector receives external power to charge the battery; and
an output connector disposed on at least a portion of the handle to connect to an external device, such that the output connector charges the external device.

5. The cable tie wrapping device of claim 1, further comprising:
a tie wrap compartment disposed on at least a portion of the pole to store at least one other cable tie therein.

6. The cable tie wrapping device of claim 1, further comprising:
an electromagnetic shielding unit disposed on at least a portion of the tie wrapping assembly to impede a current from the cable from being transferred to at least one of the pole, the tie wrapping assembly, and the handle assembly.
